(19) United States
(12) Patent Application Publication
(10) Pub. No.: US 2026/0036500 A1
(43) Pub. Date: Feb. 5, 2026

(54) APPARATUS FOR TESTING SWIVELS AND METHOD FOR SAME

(71) Applicant: Tallman Equipment Co., Columbus, IN (US)

(72) Inventors: Edward F. Youngerman, St. Charles, IL (US); Andrew F. Finn, Elmhurst, IL (US); Sara E. Hassell, Oakbrook Terrace, IL (US); Sean P. Galligar, Cary, IL (US)

(73) Assignee: Tallman Equipment Co., Columbus, IN (US)

(21) Appl. No.: 19/095,118

(22) Filed: Mar. 31, 2025

Related U.S. Application Data
(63) Continuation-in-part of application No. 18/790,755, filed on Jul. 31, 2024.
(63) Continuation-in-part of application No. 18/790,742, filed on Jul. 31, 2024.

(51) Int. Cl. G01N 3/08; G01N 3/06

(52) U.S. Cl. CPC G01N 3/08; G01N 3/06; G01N 2203/0658

(57) ABSTRACT

An apparatus to test swivels includes at least one sensor structured to measure one or more observable responses to a swivel rotating under tension in a testing apparatus. The apparatus to test swivels also includes a swivel testing controller coupled to the at least one sensor, and structured to receive an observable response input regarding the swivel being tested. The swivel testing controller is operable to compare the observable response input of the swivel to a model swivel response, and output a swivel health diagnostic signal based on the comparison. A methodology for setting up a swivel testing system and a methodology for testing a swivel are also disclosed herein.

### CROSS-REFERENCE TO RELATED APPLICATIONS

The present disclosure is a continuation-in-part of U.S. patent application Ser. No. 18/790,755, filed Jul. 31, 2024, and a continuation-in-part of U.S. patent application Ser. No. 18/790,742, filed Jul. 31, 2024, the entire disclosures of which are incorporated herein by reference.

### FIELD

The claimed technology relates generally to testing industrial equipment and more particularly to an apparatus for setting up a swivel testing system and for testing swivels.

### BACKGROUND

Industries which utilize heavy cables such as power transmission and lifting/rigging all typically use swivels in applications where a cable may be subjected to both tension (pulling) forces as well as torsion (twisting) forces. Employing swivels may help minimize twisting of cables during installation, as they allow the line to rotate slightly around its axis without transmitting the twist further down the line. Such swivels typically include a central body portion pivotably connected to two end portions. Each end portion includes an attachment feature such as a pin to allow the swivel to be attached to one or more cables. A gap may be present between the central body portion and each end. When subjected to a tension load the swivel is designed to allow one or both of the end portions to rotate when subjected to torque, typically applied by an attached cable which tries to twist.

High-tension power transmission and distribution lines are typically run from one tower to the next by pulling one conductor cable off of a large spool or drum joined to another cable or high tensile rope by a swivel. Pulls of over 1 km are not uncommon in the power transmission industry in rural areas which might generate thousands of Newtons of tension on the cables as well as on the swivel. Additionally, as the conductor cable or rope is pulled linearly it also twists creating torsional forces which can cause the conductor cable and/or rope to break. The sudden failure of heavy cables under such high tension can be extremely dangerous to workers and equipment.

Swivels used in such applications must be able to readily rotate in response to torque applied by the cable being pulled while under very high tension. Over time, these swivels can sometimes degrade in performance and lose their ability to rotate when subjected to torque while under tension. Differentiating between good and potentially failing swivels can be difficult, especially because a swivel may behave normally under no or lower tension loads but resist or even stop rotating altogether when subjected to higher tension loads normally associated with long runs of cable.

That is, a swivel may pass a visual inspection and even appear to operate normally at the beginning of a pull only to fail catastrophically once a higher tension load is applied, potentially through failure of the swivel itself but more commonly due to failure of an attached cable which is caused to twist when the swivel fails to rotate. What is needed are strategies for testing swivels to determine if they still can be used at a predetermined safety threshold.

### SUMMARY

In one aspect methods of testing an industrial swivel include applying a first tension force to the swivel being tested, applying a first rotational force to the swivel thereby causing the swivel to rotate in a first direction, increasing the tension force on the swivel to a second tension force over a first period of time, maintaining the second tension force and first rotational force on the swivel for a second period of time, ceasing the first rotational force and applying a second rotational force to the swivel, maintaining the second tension force and second rotational force in the second direction on the swivel for a third period of time, and reducing the tension force on the swivel to the first tension force over a fourth period of time. The first tension force may be equal to 10% of the rated working load of the swivel being tested and the second tension force equal to 125% of the rated working load of the swivel being tested. The first, second, third, and fourth periods of time may be equal, and each may be one minute in duration. The first rotational force and the second rotational force may cause the swivel to rotate in opposite directions and such forces may cause the swivel to rotate at a speed of 10 rpm. Optionally, after reducing the tension force on the swivel to the first tension force over a fourth period of time the second rotational force to the swivel may be ceased, and then the tension force may be reduced to zero. After testing the swivel may be marked with indicia relating to the test, and if the swivel ceases to rotate and/or requires torque which exceeds a predetermined threshold when subjected to the first rotational force or the second rotational force the indicia may indicate failure of the test.

In another aspect a method of testing a swivel is disclosed, including mounting a swivel in a testing apparatus, selecting test parameters, applying a first tension force to the swivel, applying a first rotational force to the swivel causing the swivel to rotate, increasing the tension force on the swivel to a second tension force over a first period of time, maintaining the second tension force and first rotational force on the swivel for a second period of time. The swivel fails the testing procedure if it ceases rotation or if it exceeds a predetermined torque threshold during the first or second period of time. Further, a second rotational force is applied to the swivel, maintaining the second tension force and second rotational force in the second direction on the swivel for a third period of time, where the swivel fails the testing procedure if it ceases rotation or if it exceeds a predetermined torque threshold during the third period of time. The method still further includes reducing the tension force on the swivel to the first tension force over a fourth period of time where the swivel fails the testing procedure if it ceases rotation or if it exceeds a predetermined torque threshold during the fourth period of time. The method may also include ceasing the second rotational force on the swivel when the first tension force is reached, reducing the tension force on the swivel to zero, and marking the swivel with a certification mark relating to the test. After completion of the test sequence the certification mark and/or data corresponding to the certification mark may be entered into a database. The first, second, third, and fourth periods of time may be equal and the first and second rotational forces may be in opposite directions.

In a further aspect a test platform for testing swivels includes a testing assembly having a first portion and a second portion connected by at least one support member and defining a testing volume between the first portion and the second portion, the first portion having a hydraulic cylinder configured to apply tension forces and operationally connected to a fixed upper connection member having a first swivel attachment point disposed within the testing volume, and the second portion having a drive system operationally connected to a rotatable driveshaft, the rotatable driveshaft being operationally connected to a second swivel attachment point disposed within the testing volume, and the drive system being configured to apply rotational forces to the rotatable driveshaft. A torque transducer may be disposed between the drive system and the rotatable driveshaft configured to measure torque applied by the drive system to the rotatable driveshaft. The drive system may include a hydraulic and/or electric motor. The test platform may optionally include one or more universal joints between the rotatable driveshaft and the second swivel attachment point. A controller device having a display, a memory, a processor, and an input interface may be operationally attached such that the controller is operationally connected to the drive system and the hydraulic cylinder. The controller device may be configured to control the rotational forces applied by the drive system to the rotatable driveshaft and the tension forces applied by the hydraulic cylinder to the upper connection point. The controller may also be configured to receive information from the torque transducer relating to torque applied by the drive system to the rotatable drive shaft. The first swivel attachment point and the second swivel attachment point may be removable and/or configured for attachment to a specific style/make/model/brand of swivel.

In still another aspect, an apparatus for testing a line pulling swivel is provided including a testing assembly having a first portion and a second portion connected by a plurality of support members and defining a testing volume between the first portion, the second portion, and the plurality of support members, the first portion having a hydraulic cylinder operationally connected to and configured to apply tension forces to an upper connection member, and a first swivel attachment point disposed within the testing volume and connected to the upper connection member, the second portion having a drive system rotatably connected to a rotatable driveshaft and configured to selectively apply rotational forces to the driveshaft, a second swivel attachment point disposed within the testing volume and connected to the driveshaft, and where the upper and second swivel attachment points are configured for attaching to a line pulling swivel. A controller device having a display, a memory, a processor, and an input interface may also be operationally connected to the drive system and/or hydraulic cylinder and configured to control the rotational and tension forces applied to the driveshaft. The controller may also be configured to monitor the torque, tensile forces, testing time, system pressure, and/or driveshaft position. The controller may be configured to receive information from the torque transducer relating to torque applied by the drive system to the driveshaft.

In still another aspect an apparatus for testing swivels having a linear actuator with an attachment point and configured to apply tension force to a swivel attached to the linear actuator attachment point, a rotational actuator having an attachment point and configured to apply torque to a swivel attached to the rotational actuator attachment point, a swivel operationally attached to the linear actuator attachment point and the rotational actuator attachment point, and a controller operationally connected to the linear actuator and the rotational actuator and configured to measure the tension force applied to the swivel by the linear actuator and to measure the torque applied to the swivel by the rotational actuator. The controller may be further configured to signal a failure code for a swivel being tested if the swivel ceases rotating when the rotational actuator is applying torque and the linear actuator is applying tension. The controller may also be configured to signal a failure code if the controller detects an applied torque exceeding a predetermined threshold such as to cause the swivel being tested to rotate.

In still another aspect a method of testing a swivel, includes rotating a swivel, and monitoring an observable response of the swivel while rotating. Testing the swivel also includes receiving an observable response input on a swivel testing controller, and comparing the observable response of the swivel to a model swivel response.

In still another aspect a method of setting up a swivel testing system, includes subjecting each respective one of a plurality of swivels to a testing protocol in a testing apparatus. Setting up the swivel testing system also includes rotating each respective one of the plurality of swivels under tension in the testing apparatus according to the testing protocol, and monitoring an observable response of each respective one of the plurality of swivels. Setting up the swivel testing system further includes receiving an observable response input for each respective one of the plurality of swivels, and populating a database based on the observable response inputs for each of the respective plurality of swivels. Setting up the swivel testing system further includes categorizing in the database each of the respective plurality of swivels based on the observable response inputs

In still another aspect an apparatus to test swivels includes at least one sensor structured to measure one or more observable responses to a swivel rotating under tension in a testing apparatus. The apparatus to test swivels also includes a swivel testing controller coupled to the at least one sensor, and structured to receive an observable response input regarding the swivel being tested. The swivel testing controller is operable to compare the observable response input of the swivel to a model swivel response, and output a swivel health diagnostic signal based on the comparison.

### BRIEF DESCRIPTION OF THE DRAWINGS

FIG. 1 is a perspective view of a swivel;

FIG. 2 is a perspective view of a swivel testing device according to one embodiment;

FIG. 3 is a perspective view of a portion of the device shown in FIG. 2;

FIG. 4 is a perspective view of a portion of the device shown in FIG. 2;

FIG. 5 is a flowchart of a swivel testing procedure according to one embodiment;

FIG. 6 is an example test report of a passed swivel test;

FIG. 7 is an example test report of a failed swivel test;

FIG. 8 is a perspective view of a controller according to one embodiment;

FIG. 9 is a flowchart illustrating a testing protocol to set up a swivel testing system;

FIG. 10 is a swivel testing controller outputting a health diagnostic signal;

FIG. 11 is a flowchart illustrating a strategy for a swivel testing apparatus; and

FIG. 12 is an exemplary comparison of an observable response of a swivel to a model swivel response.

### DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

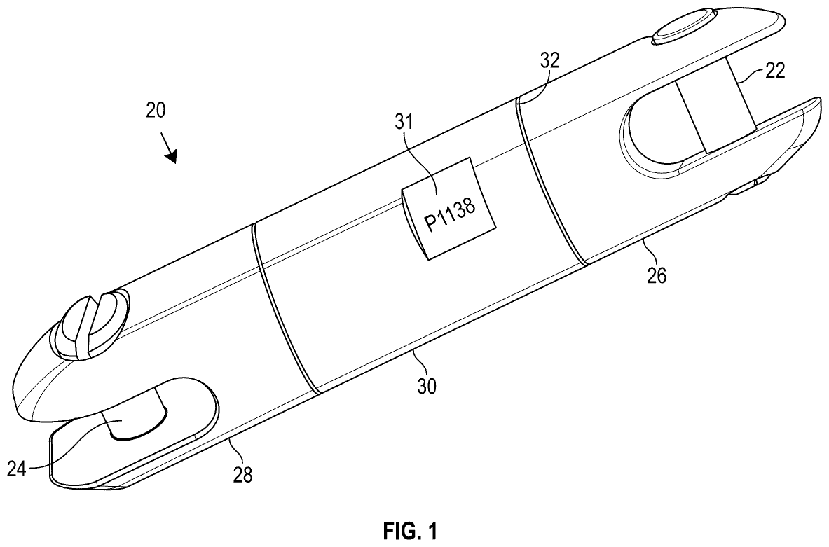

Swivels 20 such as the example shown in FIG. 1 are typically used in applications where a cable may be subjected to both tension (pulling) forces as well as torsion (twisting) forces. Swivel 20 includes a central body portion 30 connected to two end portions 26, 28. Typically one of the end portions 26, 28 is configured to rotate while the other is fixed. For example, end portion 26 might be pivotably connected to body portion 30 while end portion 28 is fixed to body portion 30 (i.e., is prevented from rotating relative to the body portion). Each end portion includes an attachment feature 22, 24 shown in this example as a pin, but in other examples different attachment features may be used on one or both ends. A gap 32 is present between the central body portion 30 and the pivoting end (in this example, end 26). When subjected to tension the gap 32 may increase temporarily. One sign of wear is that the gap 32 fails to return to its pre-tension size when a tension load is removed. Another sign of swivel wear or otherwise performance degradation is when the pivotable end portion fails to pivot, or fails to pivot smoothly, when swivel 20 is subjected to a tension load. In a practical implementation, swivels may undergo testing for various reasons, such as to verify functionality and/or durability under different applications. Such tests may allow a user to test desired parameters and apply various parameters to a swivel and indicate a fail if a swivel does not meet a predetermined requirement, discussed further herein.

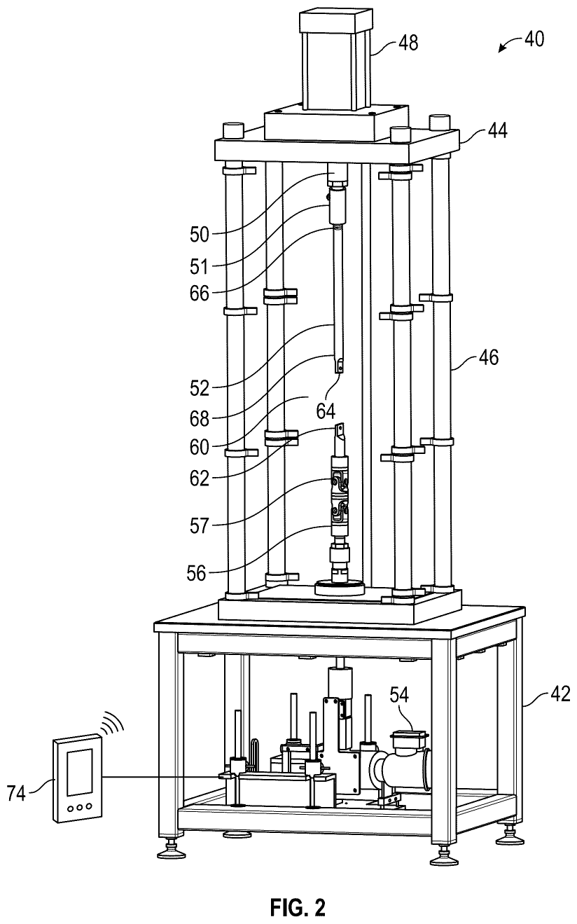

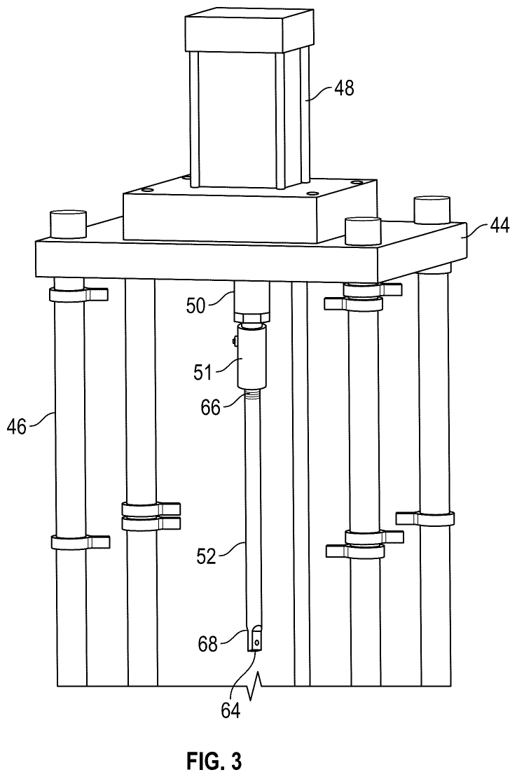

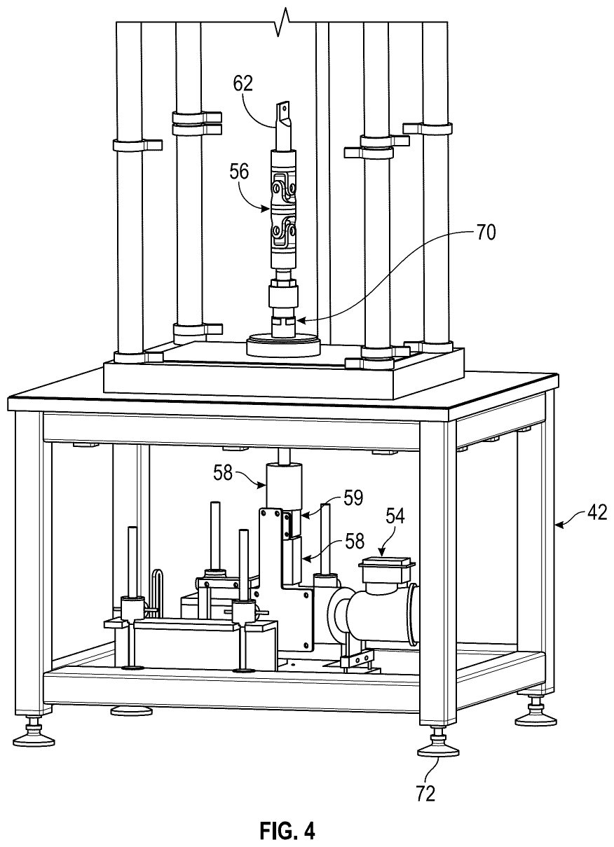

One example of a testing assembly suitable for performing the methods of testing swivels described herein is shown in FIG. 2-4. In this particular example, the testing assembly 40 includes a first portion 44 (shown in greater detail in FIG. 3) and a second portion 42 (shown in greater detail in FIG. 4) operationally connected by one or more support members 46. As illustrated, the support members 46 are of a fixed length so as to space the first portion 44 at a predetermined distance from the second portion 42. In other examples, the support members may be adjustable in length and/or the position of the first portion on the support members may be adjustable so as to allow for the distance between the first and second portions to vary. It should be appreciated that alternative strategies for support members are within the scope of the present description, provided there is a distance maintained between the first portion and second portion. The support members 46 define a testing volume 60 between the first and second portions. Optionally, the testing volume 60 may be contained within an enclosure (not shown) suitable for reducing the risk of injury or equipment damage in the event of a catastrophic failure by a swivel during a testing procedure. Such enclosure may be made from any suitable material such as metal, impact-resistant polycarbonate, and the like.

Disposed within the testing volume 60 is a first connection member 50 which is operationally connected to the first portion 44, a force transducer 51, and an extension member 52 which includes a first attachment point 64 such as a hook, eye, or other connecting mechanism. Also disposed within the testing volume 60 is a second connection member 56 which is operationally connected to the second portion 54 and includes a second attachment point 62. In one example, the first connection member 50 is designed for pulling by applying a tension force in a linear direction, while the second connection member is designed for rotating around an axis by applying a rotational force, facilitating circular moving or turning. In another example, the first connection member 50 and/or the second connection member 56 include universal joints which allow for a swivel to have some horizontal drift or “wobble” while rotating during a testing sequence while maintaining tensile force applied to the swivel along the central axis of the swivel. In yet another example, the second connection point 56 includes an additional universal joint 57. The exact configuration of the first attachment point 64 and the second attachment point 62 may vary according to the style and configuration of the swivel being tested.

In one example, the attachment points are removable so one testing apparatus may be configured to test more than one style of swivel. In another example the first attachment point 64 and second attachment point 62 are paired for a specific swivel model, type, and/or size so they may easily be selectively mounted to the testing apparatus according to the type of swivel being tested. Optionally, extension members 52 may be used to allow for swivels of different sizes and/or having different attachment portions to be mounted and tested. Extension members may have different lengths, diameters, and/or attachment features to allow for variations in swivel design. The extension member 52 includes a proximal end 66 configured for attachment to the first connection member 50 and a distal end 68 configured to include an attachment point 64. Attachment points may vary in length, diameter, and shape so as to be compatible with different makes/models/styles of swivel. In another example, the extension members are configured for attachment to the second connection member rather than the first connection member. In yet another example, an actuator may be configured to further include attachment points as further discussed herein.

The second portion 42 of the testing assembly 40 includes a drive system 54, which may include a motor configured to apply torque through one or more coupling members 58 to a rotatable driveshaft 70 operationally connected to the second connection member 56. A torque transducer 59 is disposed such that it may measure the torque provided by the drive system 54 and applied to the swivel being tested through the drive shaft 70. A torque transducer as contemplated herein includes any electrical, mechanical, or electro-mechanical mechanism for monitoring torque including virtual sensors and estimation mechanisms.

The drive system may also include a transfer case/gearing assembly operationally disposed between the motor and the drive shaft 70 configured to modify the rotational force transmitted from between the motor and the swivel 20 being tested. The motor within the drive system 54 may be an electric motor, a hydraulic motor and pump, or any other suitable mechanism capable of generating sufficient rotational force. The second portion 42 may further include one or more stabilizing and leveling members 72 such as adjustable feet to allow for the testing assembly 40 to be leveled on a support base such as a floor or workbench. Optionally, the second portion 42 may further include one or more leveling indicators such as a spirit level or leveling sensors. Such sensors may further be operationally connected to a control device 74 (described below), and a check to confirm the testing assembly is level may be performed by such control device upon initiation of a testing sequence. The first portion 44 of the testing assembly 40 includes a hydraulic system 48 having a cylinder shaft or rod (not shown) operationally connected to the first connection member 50. The hydraulic cylinder 48 or other linear actuator is configured to apply tensile force to the swivel during a testing procedure which may be measured by the force transducer 51 or by any other suitable means.

A control device 74 is operationally connected to the sensors and controllers on the testing assembly 40 either by a physical, hard-wired connection or wirelessly. The control device may be a purpose-built device having a processor, memory, and wired/wireless communication capability which is optionally mounted to or near the testing assembly 40. Alternatively, the control device 74 may be a computer, mobile device (phone or tablet) or other suitable device capable of running operational and control software for the testing assembly 40. The control device 74 may be configured to control the rotational and tension forces applied to a swivel during testing. The functionality of such control devices is discussed in greater detail below with respect to the disclosed methods of testing and certifying swivels.

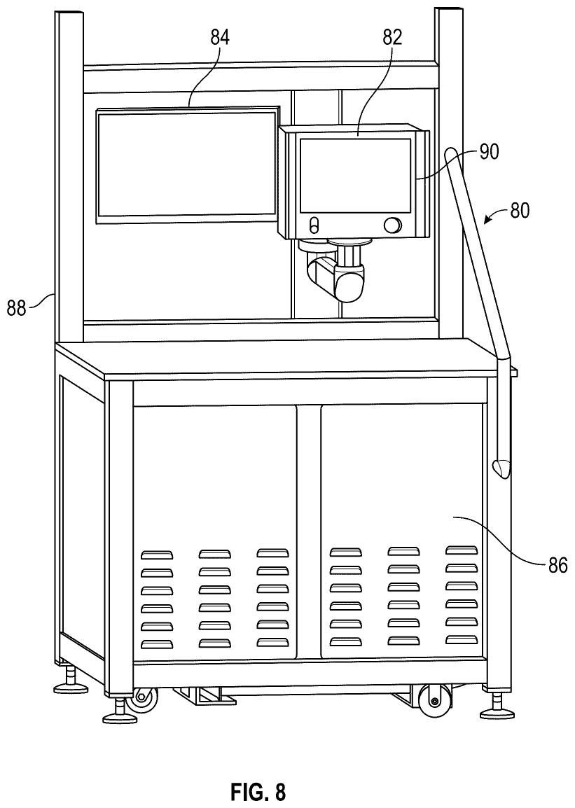

An alternative control device 80 is shown in FIG. 8. In this particular example the control device 80 is housed in a movable cabinet 88 which holds the human-machine interface 82 which includes a computer 84 (having a processor, memory, storage, and wireless and/or wired data transmission components) as well as a touchscreen interface/display 90. The cabinet 88 may also house a hydraulic pump and reservoir as in a housing 86 for providing a testing apparatus such as those disclosed herein with pressurized hydraulic fluid. Optionally, the cabinet may also include equipment for providing electrical power to a testing apparatus.

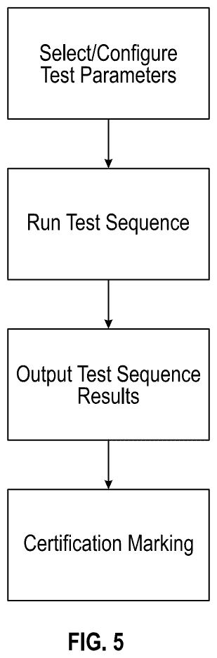

Testing and certification of swivels such as that shown in FIG. 1 may be accomplished using the methods disclosed herein. Although the methods disclosed herein are directed to testing and certification of swivels, testing may also be applicable to various machine components which operate under similar mechanical principles to determine suitability of the component for service based upon the components' response to such testing. Such methods may be practiced using the devices previously described herein as test beds or on other suitable devices. In one example method illustrated in FIG. 5 the test parameters are selected for the swivel to be tested. The testing parameters may include a variety of different aspects including one or more of pull force to be applied to the swivel, pull/test duration, applied rotational force duration, rotational speed (in revolutions per minute, for example), and/or rotational direction (e.g., clockwise, counterclockwise, or bi-directional). Parameters may be selected individually on a case-by-case basis or in other examples parameters may be grouped into predetermined test settings packages and/or user-defined test settings packages. Such predetermined test settings packages may be sorted by characteristics of the swivels being tested. Such characteristics may include manufacturer, rated load, age/hours of use, lifecycle rating, field of use (e.g., cable pulling or lifting rigging; underground pulling or overhead pulling), or other suitable characteristics.

Pull force (tension) for a particular testing sequence in one example will be the rated load limit (“rated load”) of the swivel being tested. In some examples, a swivel will have one rated load limit for underground cable pulling and a second rated load limit for overhead cable pulling. In such cases testing may be done at the higher of the two rated load limits, although the present disclosure is not thereby limited. In other examples, testing may be done at the lower of the two rated load limits with final certification noting that the tested swivel was only certified at the lower load limit and/or certified only for certain uses (e.g., certified only for underground cable pulling). In yet other examples, applied loads may vary during a testing sequence between higher and lower loads with the highest applied load being the rated load limit of the swivel being tested. In this particular example, tensile forces may incrementally increase and/or incrementally decrease for a period of time during the testing. In still other examples the sequence may subject a swivel to loads greater than the rated load for one or more periods of time before reducing the tension applied. Pull load duration may vary as desired, but is typically measured in minutes.

Rotational speed and/or direction for a particular testing sequence may be set at any number of revolutions per minute as desired. In some examples, a swivel may be tested at one rate of RPM for underground cable pulling and a second rate of RPM for overhead cable pulling. In such cases testing may be done at the higher of the two rates. In other examples, testing may be done at the lower of the two rates with final certification noting that the tested swivel was only certified at the lower rate of RPM. In still other examples, testing may include a rotational force which allows the swivel to rotate at a constant rate. In still other examples, the rate of revolutions for a swivel test may vary during the testing procedure such that an average RPM is set as a parameter and the testing sequence includes periods of higher and lower rotation. The direction of rotation during a testing sequence may be set as either clockwise, counterclockwise, or both (bi-directional) as desired. During the testing process, swivels may include at least one rotational testing cycle, which will be discussed further subsequently.

Once the testing parameters have been selected (either individually or as a package of testing parameters) a swivel is loaded into a testing apparatus and the testing sequence initiated. The testing sequence is then performed according to the selected parameters. Optionally, real time data may be generated by one or more sensors on the testing apparatus, the data collected, stored, and/or transmitted to an output device such as a display screen, printer, or a separate device such as a computer or mobile device. Collected testing data may include one or more of pull force, system pressure, applied RPM, torque required to turn the swivel being tested, rotational position of the swivel relative to the starting orientation, load/RPM of the test bed motor(s) and/or pumps, status of certain variables at a point of swivel failure, and other desired variables or status information of the system. In one example, a torque input may be received from a torque transducer coupled to a swivel. Suitability of the swivel for service may then be determined by comparing a torque indicated by the torque input to a predetermined torque threshold, and a test signal, such as pass or fail, may then be provided based upon the comparison. While the present description discusses a pass or fail test signal, other test signals are within the scope of the present description, including, but not limited to indeterminate, incomplete, error, and still others.

Typically a swivel will be considered as passing a test if it continues to rotate during the entirety of periods when rotational force is applied regardless of any applied tension load. A swivel which ceases rotation, rotates irregularly, or requires torque to rotate which exceeds a predetermined threshold when a rotational force is applied will be considered to have failed. As previously discussed, a swivel which fails to properly rotate when subjected to tension loads can be dangerous when pulling heavy cable over long distances by subjecting the cable to torque potentially resulting in catastrophic failure of the cable and/or the swivel.

A test report may be generated after a testing sequence has been completed for a particular swivel. Such reports may include objective criteria, subjective criteria, or both. For example, one or more of a generic indication of pass/fail if any one tested aspect of a swivel fails, a more specific indication of pass/fail for particular aspects of a testing sequence (e.g., pass tension load test, fail rotational load test), peak rotational speed achieved, peak tension load applied, peak torque applied, swivel gap width before, after, and during testing, noises observed during testing (e.g. grinding, squealing, etc.), odors observed during testing, swivel temperature increases detected during testing, wobble/sway observed, hesitation/pauses during rotational testing, and the like. Optionally, a code (alphanumeric, bar code, QR code, and the like) may be etched or otherwise placed on a particular swivel so that an end user might access such test results, or a pass condition versus failed condition, a load rating, a revised load rating, or other information stored in a database for later reference. Such a system would allow users to track a specific swivel's test history over time as well as allowing later purchasers of a used swivel to access test history before they actually use a previously tested swivel in the field. Optionally, such test results may also include recommendations as to limits to be placed on a particular swivel's future use. For example, it might be recommended that a swivel only be used a certain number of times in total, a certain number of times per year/month, that it only be used at loads lower than its original rating, and/or that it be recertified by testing again within a certain time window (e.g., 6 months) and/or after a certain amount of use (e.g., 100 hours of use).

Once a particular swivel has been subjected to a testing sequence one or more certification indicia may be applied to the swivel. If a swivel fails to satisfy one or more aspects of a testing sequence an indicium indicating “failure” may be stamped, etched, engraved, stickered, or otherwise placed on the swivel housing. Optionally, the specific reason(s) for failure may also be indicated. For example, a swivel might pass the tension load aspect of a testing sequence (e.g., it does not fail under tension) but fail the rotational aspect of the testing sequence (e.g., it stops rotating when over a certain tension threshold but begins rotating once it is under that tension threshold). Such a swivel might be marked as “tension load=passed; rotation load=failed. In still other examples, such a swivel might be marked as having conditionally passed a testing sequence. That is, it might be marked as passed for use under the tension threshold where rotation ceased but unsuitable for higher tension loads. As a swivel ages it might be passed for lower and lower tension loads until it ultimately fails for any load no matter how low and must be retired from use. Such downward revision of a swivel's rated tension load might allow for a longer useful life for swivels albeit at lower tension loads as they age.

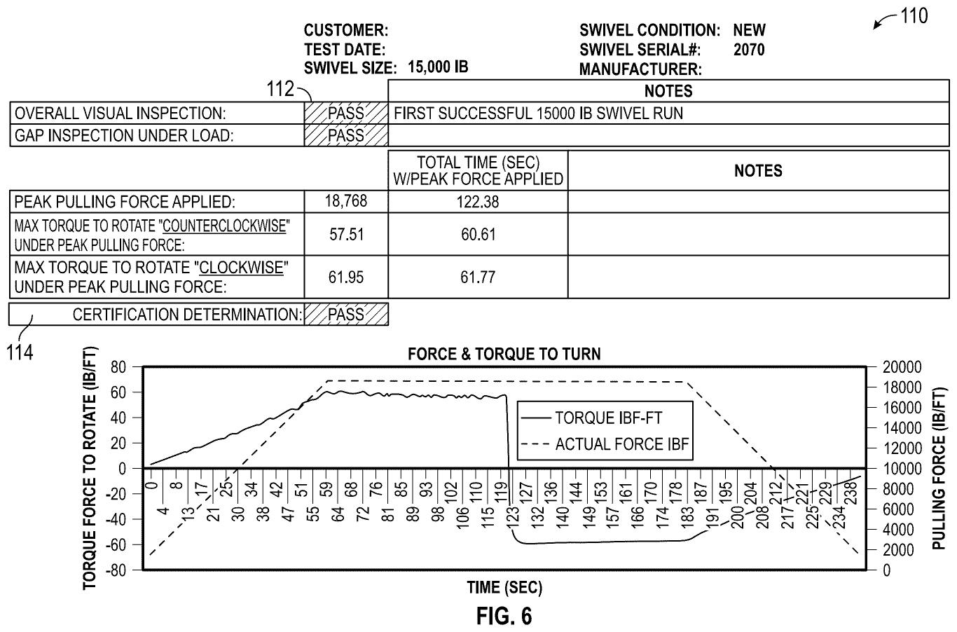

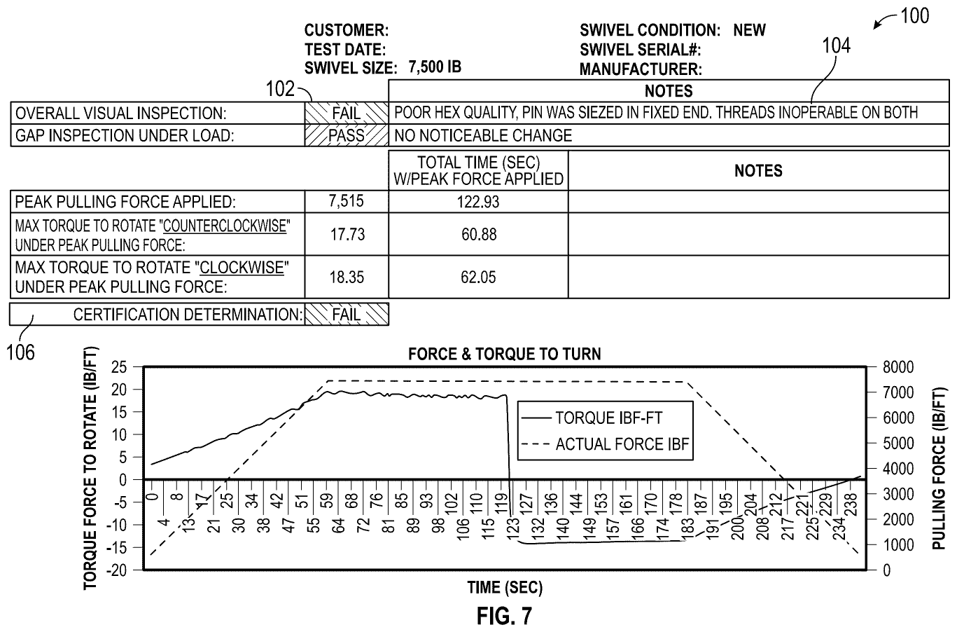

Examples of test reports are shown in FIG. 6-7. FIG. 6 shows a test report 110 for a swivel which passed a test procedure. The report includes information about the swivel including manufacturer, serial number, and rated capacity. The report further includes both subjective information 112 provided by the technician who performed the test procedure as well as objective information 114 concerning the test procedure and test results.

FIG. 7 shows a test report 100 for a swivel which failed a test procedure. The report includes information about the swivel including manufacturer, serial number, and rated capacity. The report further includes both subjective information 102 and comments 104 provided by the technician who performed the test procedure as well as objective information 106 concerning the test procedure and test results. Optionally such test reports may be accessible via indicia marked on the swivel after the testing procedure as previously described.

In one example of a swivel testing and certification procedure according to the disclosed invention a swivel is loaded into a test bed apparatus, testing parameters are selected, and the testing sequence initiated. The testing sequence could be a four-minute process which includes a tension loading sequence, a rotational cycle, and a tension unloading sequence. The term “rotational cycle” as discussed herein refers to a specific period of time during which a swivel being tested undergoes repeated or periodic rotational phases. In this particular example, the testing sequence includes a tension loading sequence, a first rotational sequence, a second rotational sequence, and a tension unloading sequence. As noted above, while the present description discusses a rotational cycle including a “first rotational sequence” and a “second rotational sequence”, alternative tension and rotational sequences are within the scope of the present description. For example, a rotational cycle may additionally include additional rotation sequences, additional tension sequences, or an alternative sequence order.

In the first sequence a tension force is applied to the swivel until a fraction of the rated working load is reached. In one example the fraction of the rated working load is greater than 1%. In a refinement, the fraction of the rated working load is equal to approximately 10% of the stated working load limit. Once a fraction of the rated working load tension load is achieved clockwise rotation of the swivel at a constant rate is initiated. Once the swivel is rotating, tension force is increased from a rated working load that is a fraction of the rated working load capacity to a tension force greater than the rated working load capacity. In one example a tension force greater than the working load capacity may be approximately 125% of the rated working load, although tension forces of 100%, 110%, 150%, for example are within the scope of the present disclosure. Tension force may be increased at a steady rate over the course of a period of time. In one example, the period of time may be approximately 1 minute.

As noted above, the following is an exemplary instance of a rotational cycle, and alternative rotational cycles are contemplated. In the second sequence the swivel is rotated at a constant rate with a tension force greater than the rated working load capacity, for a period of time. In one example, the swivel may be rotated at 10 RPM at 125% load for one minute. In the third sequence clockwise rotation is halted and counterclockwise rotation at a constant rate is initiated and maintained for a period of time. While the present description discusses “clockwise” and “counterclockwise”, testing may also include other types of rotational forces provided the second rotational force varies relative to the first rotational force in at least one direction of rotation or in amplitude. In one example, during the third sequence the swivel may rotate at the same rate with the same force as in the second sequence in a different direction. In another example, the swivel may rotate at 10 RPM for one minute. In the final sequence counterclockwise rotation is maintained as tension unloading is begun. The unload cycle reduces tension from a rated working load that is greater than the rated working load capacity to a fraction of the rated working load at a constant rate for a period of time. When the tension load reaches the fraction of the rated working load counterclockwise rotation of the swivel is stopped. At the end of the testing sequence the tension load is reduced to 0%, the swivel is removed from the test bed, and the results are output to a suitable device and/or screen for review. Following testing, swivels are given an indication of test failure based upon the resistance to continued rotations. It should be appreciated that each sequence occurs over a predetermined period of time, and each sequence may be equal or vary, depending on the testing parameters. It should also be appreciated that variations on these general principles could include application of tensile forces maxing out at the rated load, maxing out at less than the rated load, or potentially multiple different tests to different loads above, below, or at a rated load.

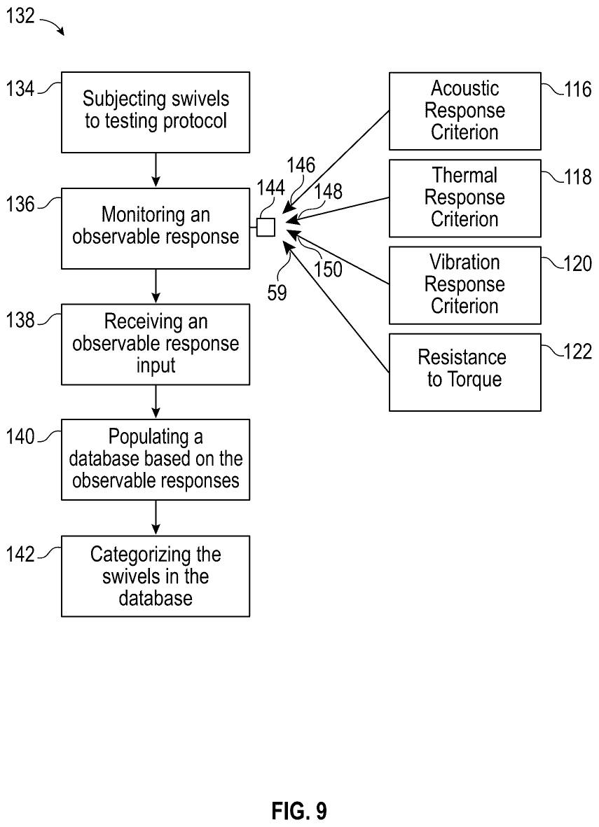

Now also referring to FIGS. 9-12, there are shown details regarding an exemplary testing protocol for setting up a swivel testing system and for testing a swivel utilizing a controller. As mentioned above, both objective and subjective criteria can be used to give an indication of a pass or a fail or other grading, for particular aspects of the testing sequence. Subjective criteria may include, for example, corrosion, scratching, color changes, external damage, or still other characteristics. Objective criteria may include monitoring various observable responses for swivel 20 when tested. In a practical implementation, these observable responses can be compared to a model swivel response, which in some instances may be deemed suitable, based on specific criteria, as further discussed herein.

It should be understood that the term “observable response,” refers to any output or physical behavior generated by swivel 20 or a plurality of swivels 20 in reaction to an input or stimulus, such as being subjected to various forces for example. These observable responses may include but are not limited to an acoustic response, a thermal response, a vibration response, a resistance to torque, and still other observable responses. It should be appreciated that the observable responses listed could also function as criteria for comparison (see blocks 116, 118, 120, 122), serving as parameters for evaluating the extent of deviation from a model swivel response, and may be considered independently or in combination.

The acoustic response, at block 124, may refer to, for example, an acoustic amplitude, an acoustic frequency, an acoustic wavelength, or an acoustic wave propagation pattern, for example. An aberration in acoustic response may include amplitude aberrations, wherein an amplitude of sound deviates from an expected amplitude, for example, or frequency aberrations, wherein the frequency of sound deviates from an expected frequency. Other aberrations in acoustic response may include explicit phenomena, for instance, screeching. The thermal response, at block 126, may be characterized by a change in temperature of a swivel, for instance frictional heating of bearings or a swivel housing, for example. The vibration response, at block 128, may be characterized by one or more of a vibration frequency, a vibration amplitude, or a vibration pattern including a combination of frequencies and/or amplitudes.

An aberration in vibration response may include a deviation in at least one of an amplitude aberration or a frequency aberration relative to a baseline or reference. The resistance to torque, at block 130, may be when swivel 20 ceases rotation, rotates irregularly, or requires torque to rotate which exceeds a predetermined threshold when a rotational force is applied.

Focusing now on FIG. 9, there is shown a testing protocol for setting up a swivel testing system in a flowchart 132. In a practical implementation, a plurality of swivels 20 may undergo the testing protocol, and observable responses for each of the plurality of swivels 20 can be compared for various purposes. Blocks 134, 136, 138, 140, and 142 of flowchart 132 outline exemplary sequential steps and logical framework for implementing setup of the swivel testing system. As shown at block 134 of flowchart 132, setting up the swivel testing system may include subjecting each respective one of a plurality of swivels 20 to a testing protocol while in testing assembly 40. The testing protocol may further include rotation of each respective one of the plurality of swivels 20 under tension in this example, in a similar manner to the swivel testing and certification procedure discussed above. Put differently, rotating each respective one of the plurality of swivels 20 under tension in testing assembly 40 according to the testing protocol may include applying a first tension force to swivel 20 and applying a rotational force to swivel 20, then increasing the tension force on swivel 20 to a second tension force, and so on.

From block 134 flowchart 132 advances to a block 136, and each respective one of the plurality of swivels 20 may be monitored in due course for an observable response. To this end, the testing assembly 40 may further include at least one sensor 144. It should be appreciated that the at least one sensor 144 may include one or more of a sound sensor 146 or microphone, a temperature sensor 148, a vibration sensor 150, a torque transducer 59, a motion sensor, a chemo sensor, or still another type of sensor.

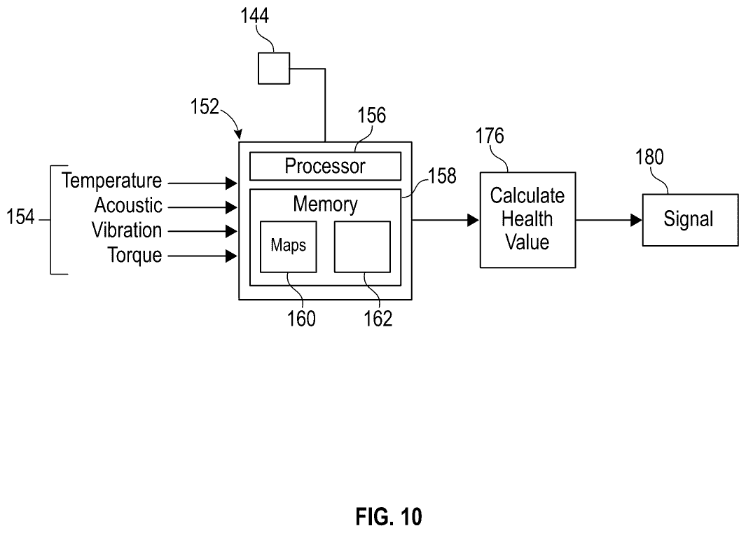

Sensor 144 is structured to measure one or more observable responses to swivel 20 rotating under tension in testing assembly 40. As can be seen in FIG. 10, testing assembly 40 may include a swivel testing controller 152 coupled to the at least one sensor 144. From block 136 flowchart 132 advances to a block 138, where swivel testing controller 152 receives an observable response input 154 regarding the specific swivel being tested.

Swivel testing controller 152 may include a processor 156 to execute operational instructions. Swivel testing controller 152 may also include a memory 158 for storage, and one or more maps 160 structured to relate inputs to output signal values or the like. Additionally, swivel testing controller 152 may include a communication module 162 for wireless control via Wi-Fi, Bluetooth, or Ethernet, for example. It should be appreciated that swivel testing controller 152 may include any combination of features from control device 74 and control device 80, individually or together.

Now advancing from block 138 of flowchart 132 to a block 140, swivel testing controller 152 receives an observable response input 154 for each respective one of the plurality of swivels 20. A database can be populated based on observable response input 154 for each of the respective plurality of swivels 20. That is, the database may include data indicative of observable responses received from the plurality of swivels. From block 140 flowchart 132 advances to a block 142 to categorize in the database each of the respective plurality of swivels based on the observable response inputs 154.

It should be appreciated that the plurality of swivels in the database may be categorized, grouped, or otherwise organized based on one or more of an acoustic response criterion, a thermal response criterion, a vibration response criterion, or a resistance to torque, for example. The database may be customized based on the types of swivels undergoing the testing protocol. Techniques for categorizing, grouping, or organizing could include filtering, sorting, and/or aggregation to enable structured access and analysis. The database might include, for example, for each tested swivel a swivel type, a swivel material, a vibration response, an acoustic response, a resistance to torque response, or still other swivel characteristics.

In a practical implementation, a swivel health data model may be populated and established based on the database. The swivel health data model may include, for example, a plurality of parameters, each of which corresponds to a different observable response. In one example, the swivel health data may include a plurality of vibration amplitude thresholds, such as vibration amplitudes at a plurality of different frequencies. If any of the vibration amplitude thresholds is exceeded by the vibration amplitude observed in a tested swivel, then the swivel is assigned a certain health value, potentially a failed health value. Other parameters of a swivel health data model could include a vibration frequency, for example, if a certain vibration frequency is observed in a tested swivel then the swivel is assigned a certain health value. Other implementations of a swivel health data model could include multiple different factors, for example a plurality of vibration amplitude thresholds and a plurality of vibration frequency thresholds.

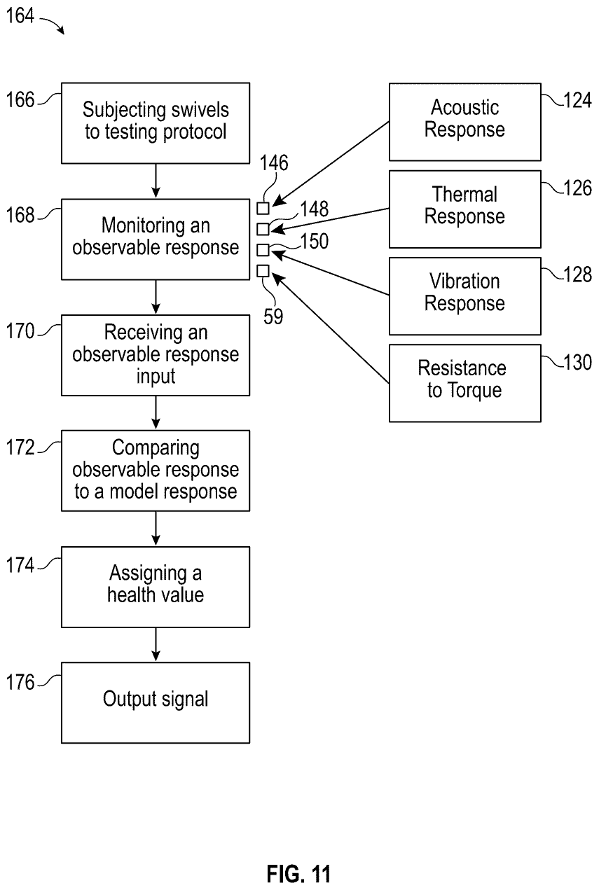

Now focusing on FIG. 11, illustrated is a flowchart 164 outlining the sequential steps and logical framework for testing a swivel. As mentioned above, the observable response for swivel 20 may be compared to a model swivel response. Looking at block 166 of flowchart 164, swivel 20 may be subjected to a testing protocol, then at block 168, swivel 20 is monitored for an observable response. It should be appreciated that the testing protocol discussed herein may having at least some similarities to the testing protocol for setting up swivel testing system, as set forth in flowchart 132. From block 168 flowchart 164 advances to a block 170, and swivel testing controller 152 receives an observable response input 154, and flowchart 164 further advances to a block 172 to compare the observable response to a model response.

In some embodiments contemplated, comparing the observable response to a model response may include calculating a difference between the observable response of swivel 20 and the observable response of the model swivel based on an aberration in the observable response of swivel 20. In one example, for instance, a difference may be calculated between an observed vibration amplitude and a model-based vibration amplitude. These differences could be calculated by quantifying a deviation between the observed vibrational amplitude and the model-based amplitude, and could be expressed through metrics such as absolute error or relative error. In other examples, a quantitative method may include calculating a mean, a median, a mode, a standard deviation, a variance, or other means aimed to analyze central tendencies and data distribution.

Similarly, as further discussed herein, these differences may be evaluated in a manner that accounts for qualitative aspects, contingent upon the application. This qualitative evaluation can be assessed through, for instance, categorizing, or other response modeling to extract meaningful patterns. In one example, a difference may be calculated between an observed vibration pattern and a model-based vibration pattern utilizing both qualitative and quantitative aspects. These differences could be calculated by using cross-correlation, root mean square error, spectral analysis, visual perceptual comparisons, amplitude variations, frequency modulation, shifts in vibration, mean, median or mode, and still other strategies.

From block 172 flowchart 164 advances to a block 174 to assign a health value to swivel 20 via swivel testing controller 152 based on comparing the observable response of swivel 20 to the model swivel response. It should be appreciated that the term “health value,” as used herein can be understood to include both quantitative and qualitative representations. For example, quantitatively, a health value may include a numerical value, such as 1, 2, 3, and so on. In other examples, a qualitative representation of a health value may include values such as a, b, c, or terms like good, bad, indeterminate, and so on. As shown in FIG. 10, at a block 176, calculating differences between the health value of swivel 20 and the health value of a model swivel can be determined using, for example, numerical values, such as those described above.

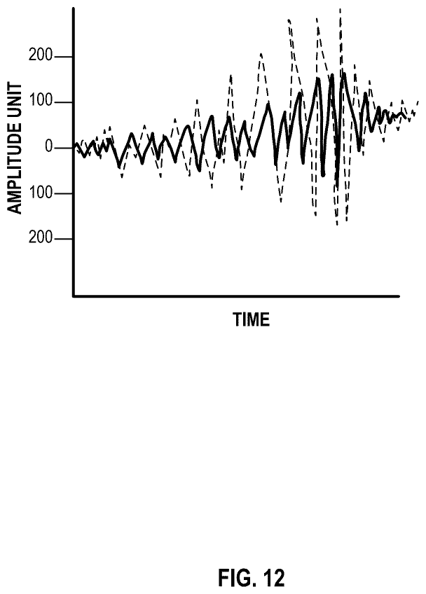

In the example shown in FIG. 12, comparing the observable response of swivel 20 to the model response includes comparing a vibration response of swivel 20 to a model vibration response. In this example, swivel testing controller may calculate a difference between the vibration response of the tested swivel and the model vibration response based upon an aberration in vibration response of the tested swivel. This aberration could be determined by calculating a difference in vibration frequency. The aberration could additionally, or alternatively, be determined by calculating a difference in vibration amplitude, measuring a magnitude or strength of the oscillation of swivel 20, and could be expressed, for example, in dimensional units (displacement).

Additional measurements potentially associated with the vibration of swivel 20 could include vibration peak amplitude/displacement, vibration peak velocity, vibration peak acceleration, or still some other measurement associated with the vibration response of swivel 20. Further examples might include a number of vibrations above, or below, a threshold amplitude, a number of vibrations at, above, or below a threshold frequency, and combinations of these and other strategies. In a practical implementation, the vibration sensor may be a three-dimensional (3D) sensor and is structured to observe movements or vibrations within a three-dimensional framework. Another way to understand this principle is that the sensor is capable of capturing motion, or vibrational motion along X, Y, and Z axes.

The example in FIG. 12 illustrates a comparative vibration amplitude of swivel 20 and a model swivel, showing displacement during the testing protocol, and measured relative to an estimated zero point. It should be understood within the present discussion that the “zero point,” represents a baseline or undisturbed state of swivel 20 prior to recording data. Put differently, the zero point indicates the level of no vibration and serves as the reference point for measuring any displacement caused by vibration. For clarity, the vibration response of swivel 20 is indicated with a dashed line pattern, and the model swivel vibration response is indicated with a solid line pattern.

Referring back now to FIG. 11, from block 174 flowchart 164 advances to a block 178 to output a swivel health diagnostic signal 180 encoding the health value based on the comparison. It should be appreciated that the health value assigned to each of the plurality of swivels may be one of a finite number of health values corresponding to a finite number of swivel health groupings. The number of health value groupings can vary depending on the characterization strategy for forming each health value grouping. For instance, in one example, the finite number of health value groupings is at least three. In this example, the three health groupings could be indicative of a pass, a fail, or an indeterminate test result, along with other potential factors for determining suitability. In another example, a plurality of model swivels could be identified, each representing a type of swivel tested, and each subsequent swivel under testing could then be compared to a corresponding model swivel. In a practical implementation, a fail signal may be output for swivel 20 via the swivel testing controller 152 based on the comparing the observable response of swivel 20 to the model swivel response. In a refinement example, a fail signal for a given swivel being tested may be output when the comparison of one or more observable responses to the model swivel response satisfies a failure criterion. In another practical implementation, the fail signal may be output based on a calculated health value.

The swivel health diagnostic routine could be set up so that if more than one threshold is exceeded, or more than one condition observed, then the tested swivel is assigned a certain health value. Still other variations could include combinations of different observable responses, for example, vibration amplitude, vibration frequency, audible sounds, and/or resistance to rotation response. A swivel health data model according to the present disclosure could be validated by way of empirically gathered swivel testing data, e.g. observable responses for swivels that are known or determined to be defective, or by simulation, or by combinations of these.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1. A method of testing a swivel, comprising:
rotating a swivel;
monitoring an observable response of the swivel while rotating;
receiving an observable response input on a swivel testing controller; and
comparing, on the swivel testing controller, the observable response of the swivel to a model swivel response.

2. The method of claim 1 further comprising applying a tension force to the swivel while rotating the swivel.

3. The method of claim 1 further comprising calculating a health value for the swivel based on the comparing the observable response of the swivel to the model swivel response.

4. The method of claim 3 further comprising outputting a fail signal for the swivel based on the calculated health value.

5. The method of claim 1 wherein the observable response includes any one or more of a thermal response, an acoustic response, a vibration response, or a resistance to rotation response.

6. The method of claim 5 wherein the observable response includes the vibration response, and the vibration response is characterized by one or more of a vibration frequency, a vibration amplitude, or a vibration pattern.

7. The method of claim 6 wherein the comparing the observable response of the swivel to the model swivel response includes comparing a vibration response of the swivel to a model vibration response.

8. The method of claim 7 further including calculating on the swivel testing controller a difference between the vibration response of the swivel and the model vibration response based upon an aberration in vibration response of the swivel.

9. The method of claim 8 wherein the aberration includes at least one of an amplitude aberration or a frequency aberration.

10. A method of setting up a swivel testing system comprising:
subjecting each respective one of a plurality of swivels to a testing protocol including rotation under tension in a swivel testing assembly;
monitoring an observable response of each respective one of the plurality of swivels;
receiving an observable response input for each respective one of the plurality of swivels;
populating a database based on the observable response inputs for each of the respective plurality of swivels; and
categorizing in the database each of the respective plurality of swivels based on the observable response inputs according to one or more of an acoustic response criterion, a thermal response criterion, a vibration response criterion, or a resistance to rotation criterion.

11. The method of claim 10 wherein the observable response includes a vibration response characterized by one or more of a vibration frequency, a vibration amplitude, or a vibration pattern.

12. The method of claim 11 further including establishing a swivel health data model based on the observable response inputs populating the database.

13. The method of claim 12 wherein rotating the plurality of swivels under tension includes applying a tension force and applying a rotational force.

14. The method of claim 11 wherein rotating the plurality of swivels under tension further includes increasing the tension force from a first tension force applied during a first time duration to a second tension force applied during a second time duration.

15. An apparatus to test swivels comprising:
at least one sensor structured to measure one or more observable responses of a swivel rotated under tension in a testing apparatus; and
a swivel testing controller coupled to the at least one sensor, and operable to:
receive an observable response input from the sensor regarding a swivel being tested; and
compare the observable response to a model swivel response; and
output a swivel health diagnostic signal based on the comparison.

16. The apparatus of claim 15 wherein the swivel health diagnostic signal encodes a health value from among a finite number of health values.

17. The apparatus of claim 15 wherein the swivel testing controller outputs a fail signal for the swivel wherein the comparison of the one or more observable responses to the model swivel response satisfies a failure criterion.

18. The apparatus of claim 15 wherein the at least one sensor includes a vibration sensor.

19. The apparatus of claim 17 wherein the observable response includes any one or more of a thermal response, an acoustic response, a vibration response, or resistance to rotation response.

20. The apparatus of claim 19 wherein the swivel testing controller is structured to calculate a difference between the vibration response of the swivel and the model swivel response based upon an aberration in a vibration response of the swivel, and the aberration includes at least one of an amplitude aberration or a frequency aberration.
